(19) United States
(12) Patent Application Publication
(10) Pub. No.: US 2011/0055051 A1
(43) Pub. Date: Mar. 3, 2011

(54) COMMUNICATION DEVICE AND COVER UNIT FOR COVERING COMMUNICATION TERMINAL

(75) Inventor: Yoshimi Urushibata, Shizuoka (JP)

(73) Assignee: TOSHIBA TEC KABUSHIKI KAISHA, Tokyo (JP)

(21) Appl. No.: 12/871,046

(22) Filed: Aug. 30, 2010

(30) Foreign Application Priority Data
Aug. 31, 2009 (JP) 2009-200802

(51) Int. Cl. G06Q 50/00; G06Q 30/00

(52) U.S. Cl. 705/27.1

(57) ABSTRACT

According to one embodiment, a communication device of a certain embodiment includes a communication terminal including a first component having a display section provided on a front surface, a second component having an operation button unit provided on a front surface, and a coupling section configured to openably and closably couple the first and second components. The communication device also includes a first cover configured to cover a front surface of the communication terminal in a state in which the first and second components are open and including at least two windows arranged in positions corresponding to the display section and the operation button unit.

### CROSS-REFERENCE TO RELATED APPLICATIONS

This application is based upon and claims the benefit of priority from Japanese Patent Application No. 2009-200802, filed on Aug. 31, 2009; the entire contents of which are incorporated herein by reference.

### FIELD

Embodiments described herein relate generally to a communication device used by a customer when a customer makes an order on table of an eating house such as a restaurant and a cover unit for covering a communication terminal of the communication device.

### BACKGROUND

In recent years, an order managing system is used in order to accurately and quickly communicate an order of a customer to cooks in an eating house such as a restaurant. In the order managing system, a handy terminal individually carried by a store clerk is used for inputting order data. The input order data is transmitted to a radio communication unit set on a ceiling or the like and configured to enable radio communication with the handy terminal. The order data is transmitted from the radio communication unit to a kitchen printer for instructing cooks in a kitchen about order menu items and a POS (Point of Sales) terminal as a checkout apparatus set on a checkout counter.

From the viewpoint of improvement of efficiency of operation, a reduction in personnel expenses, and the like, in some case, a customer order terminal with which a customer himself or herself can make an order is provided on each of tables. Like the handy terminals, such a customer order terminal can communicate with the radio communication unit by radio. Order data input to the customer order terminal is transmitted to the radio communication unit.

### BRIEF DESCRIPTION OF THE DRAWINGS

FIG. 1 is a schematic diagram of an order entry system of a first embodiment;

FIG. 2 is a perspective view of an open state of a second component of a handy terminal of the first embodiment viewed from a front surface side;

FIG. 3 is a perspective view of a closed state of the second component of the handy terminal of the first embodiment viewed from the second component side;

FIG. 4 is a block diagram of a control system for the handy terminal of the first embodiment;

FIG. 5 is a perspective view of a communication device of the first embodiment viewed from the front surface side of the handy terminal;

FIG. 6 is a plan view of the communication device of the first embodiment viewed from a rear surface side of the handy terminal;

FIG. 7 is a perspective view of a first cover of the communication device of the first embodiment viewed from the front surface side of the handy terminal;

FIG. 8 is a plan view of the first cover of the communication device of the first embodiment viewed from the rear surface side of the handy terminal;

FIG. 9 is a perspective view of a second cover of the communication device of the first embodiment viewed from the rear surface side of the handy terminal;

FIG. 10 is a plan view of the second cover of the communication device of the first embodiment viewed from the front surface side of the handy terminal;

FIG. 11 is a perspective view of a communication device of a certain modification of the first embodiment viewed from a front surface side of a handy terminal;

FIG. 12 is a perspective view of a communication device of a certain modification of the first embodiment viewed from a front surface side of a handy terminal; and

FIG. 13 is a perspective view of the communication device of the modification shown in FIG. 12 viewed from the front surface side of the handy terminal.

### DETAILED DESCRIPTION

In general, according to one embodiment, a certain embodiment provides a communication device including: a communication terminal including a first component having a display section provided on a front surface, a second component having an operation button unit provided on a front surface, and a coupling section configured to openably and closably couple the first and second components; and a first cover configured to cover a front surface of the communication device in a state in which the first and second components are open and including at least two windows arranged in positions corresponding to the display section and the operation button unit.

Another embodiment provides a communication device including: a communication terminal including an operation section on a front surface; and a cover configured to cover a side of the communication terminal on which the operation section is provided and including a window for exposing a portion of the operation section to the outside, wherein the operation section includes, in a position covered with the cover, a mode switching section configured to switch a mode.

Another embodiment provides a cover unit configured to cover a communication terminal including a first component and a second component that is opened and closed between a state in which the second component is opened with respect to the first component and a state in which the second component is closed with respect to the first component, the cover unit including: a first cover attached to a front surface side of the first component and the second component exposed to an outer side in the state in which the second component is opened; and a second cover attached to a rear surface side of the first component and the second component on the opposite side of the front surface side in a state in which the second component is opened, wherein the first cover includes: a display section window arranged in a position corresponding to a display section provided on the front surface of the first component when the cover unit is attached to the communication terminal; and an operation button unit window arranged in a position corresponding to an operation button unit provided on the front surface of the second component when the cover unit is attached to the communication terminal.

### First Embodiment

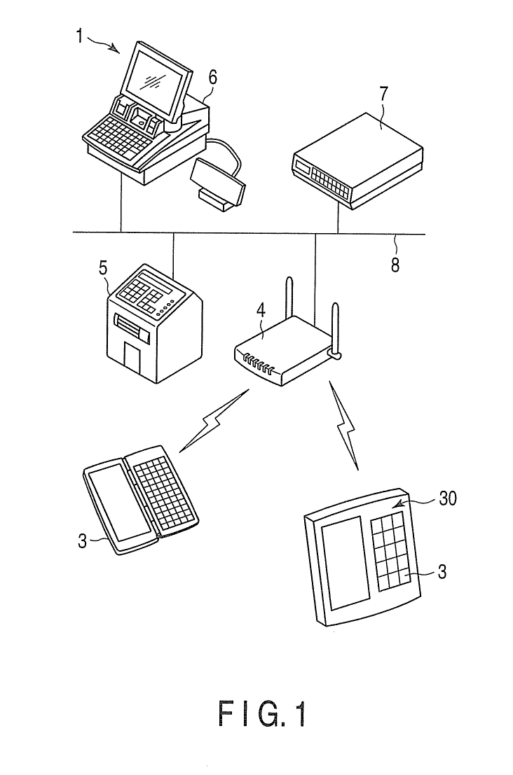

A first embodiment is explained with reference to FIGS. 1 to 10.

FIG. 1 is a diagram of an order entry system 1 as an order managing system of this embodiment used in an eating house such as a restaurant. The order entry system 1 includes plural handy terminals 3 as transmission terminals with which store clerks or customers make orders, a radio communication unit 4 set on a ceiling or the like and configured to enable radio communication with the handy terminals 3, a kitchen printer 5 configured to print and issue a cooking instruction slip (not shown) for instructing cooks in a kitchen about order menu items, a POS (Point of Sales) terminal 6 as a checkout apparatus set on a checkout counter, and a control station 7 configured to control the entire system. The radio communication unit 4, the kitchen printer 5, and the POS terminal 6 are connected to the control station 7 by a communication line 8. Both the number of radio communication units 4 and the number of kitchen printers 5 are arbitrary. A communication device 30 incorporating the handy terminal 3 is arranged on each of tables in a store. The communication device 30 is detachably attached on a placing table or the like. A customer can make an order by himself or herself using the communication device 30.

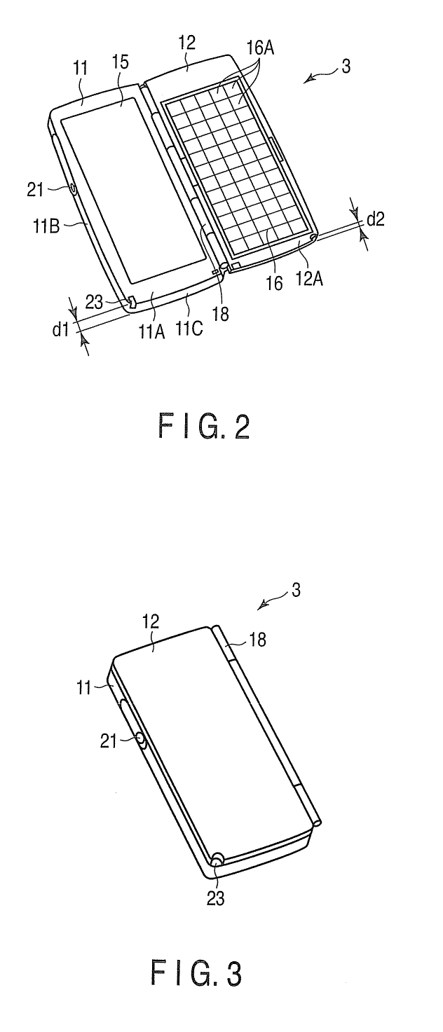

FIGS. 2 and 3 are diagrams of the handy terminal 3. As shown in FIG. 2, the handy terminal 3 includes a first component 11 having a substantially rectangular parallelepiped shape arranged on the left side and a second component 12 having a substantially rectangular parallelepiped shape arranged on the right side. The second component 12 is pivotably coupled to the first component 11 via a fastener 18 such as a hinge. The second component 12 is opened and closed with respect to the first component 11. Thickness d1 of the first component 11 is large compared with thickness d2 of the second component 12.

A display section 15 on which a menu and the like are displayed is provided on an exposed surface (a front surface) 11A of the first component 11. The display section 15 is a touch panel type display section. A store clerk can, for example, input order data and transmit the data by touching the display section 15. An operation button unit 16 including plural operation buttons 16A is provided on an exposed surface (a front surface) 12A of the second component 12.

In FIG. 3, a state in which the handy terminal 3 is closed is shown. The display section 15 of the first component 11 and the operation buttons 16A of the second component 12 are hidden from the outside.

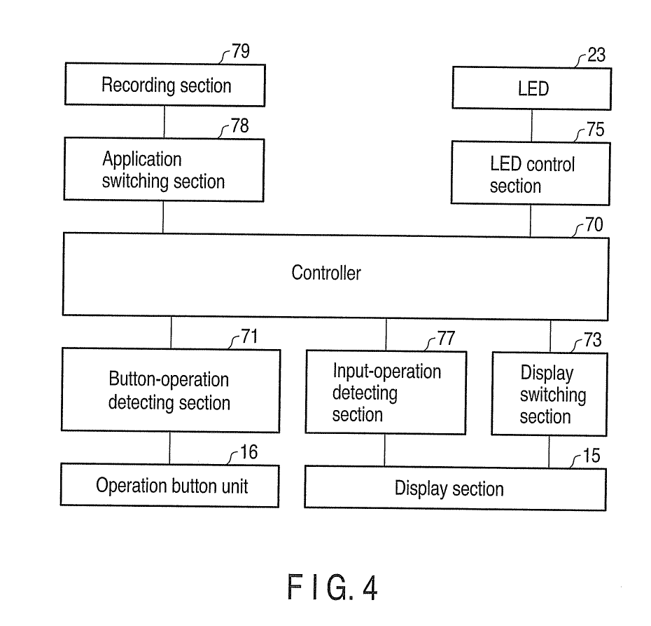

FIG. 4 is a diagram of a control system for the handy terminal 3 incorporated in the handy terminal 3. The operation button unit 16 is connected to a button-operation detecting section 71. The display section 15 is connected to a display switching section 73 and an input-operation detecting section 77. The button-operation detecting section 71, the input-operation detecting section 77, and the display switching section 73 are connected to a controller 70 configured to control the entire system. The button-operation detecting section 71 detects operation in the operation button unit 16. The input-operation detecting section 77 detects operation of the touch panel in the display section 15.

The controller 70 is connected to an application switching section 78. The application switching section 78 is connected to a recording section 79 such as a RAM. The recording section 79 has recorded therein an application in a store clerk order mode in which a store clerk individually carries the handy terminal 3 and makes an order and an application in a customer order mode in which a customer makes an order on a table. The application switching section 78 switches an application to be started between the store clerk order mode and the customer order mode. When the application of the handy terminal 3 is switched, operation for, for example, pressing a pre-set switching button of the operation button unit 16 is performed. Specifically, the handy terminal 3 includes a switching operation section for performing operation for switching the application to be started (display content of the display section 15). An input in the operation button unit 16 is detected by the button-operation detecting section 71 and sent to the controller 70. The controller 70 sends, on the basis of an input from the button-operation detecting section 71, a control signal for an application switching command to the application switching section 78. The application switching section 78 switches, on the basis of the control signal for application switching received from the controller 70, the application to be started. According to the switching of the application of the handy terminal 3, the display switching section 73 switches the display content of the display section 15 between display content for the store clerk and display content for the customer.

In this embodiment, the application to be started is switched between the store clerk order mode and the customer order mode. However, in another embodiment, the same application may be used in the store clerk order mode and the customer order mode. In this case, the application switching section 78 is not provided. When the display content of the display section 15 is switched between the store clerk order mode and the customer order mode, operation for, for example, pressing the pre-set switching button of the operation button unit 16 is performed. An input in the operation button unit 16 is detected by the button-operation detecting section 71 and sent to the controller 70. The controller 70 sends, on the basis of an input from the button-operation detecting section 71, a control signal for a display content switching command to the display switching section 73. The display switching section 73 switches the display content of the display section 15 on the basis of the control signal for display content switching received from the controller 70.

As shown in FIG. 2, a power switch 21 is provided on a side 11B on the left side in FIG. 2 of the first component 11. In the store clerk order mode, a store clerk presses the power switch 21, whereby a power supply for the handy terminal 3 is turned on. On the other hand, in the customer order mode, rather than pressing the power switch 21, a customer touches the display section 15, whereby the power supply for the handy terminal 3 is turned on. When the customer is not using the handy terminal 3, the power supply for the handy terminal 3 is automatically turned off. When the power supply for the handy terminal 3 is off, nothing is displayed on the display section 15. The controller 70 includes a terminal control section configured to control the handy terminal 3 such that, in the customer order mode, the power supply is turned on when the customer touches the display section 15 and is automatically turned off when the customer does not use the handy terminal 3 as explained above.

As shown in FIG. 2, an LED 23 is provided in a boundary portion between the surface (the front surface) 11A, on which the display section 15 is provided, of the first component 11 and a side 11C on the lower side in FIG. 2. As shown in FIG. 4, the LED 23 is connected to an LED control section 75. The LED control section 75 is connected to the controller 70. In the customer order mode, an error state such as a state in which the customer does not press a transmission button (not shown), which is provided in the display section 15, for transmitting a data transmission command to the radio communication unit 4 is detected by the input-operation detecting section 77 and sent to the controller 70. The controller 70 sends an LED lighting command to the LED control section 75 on the basis of an input from the input-operation detecting section 77. According to the LED lighting command, the LED control section 75 lights the LED 23. In other words, the LED 23 functions as a warning section for checking the error state of the handy terminal 3. On the other hand, in the store clerk order mode, the LED 23 may be used in the same manner as in the customer order mode or may be used for other purposes.

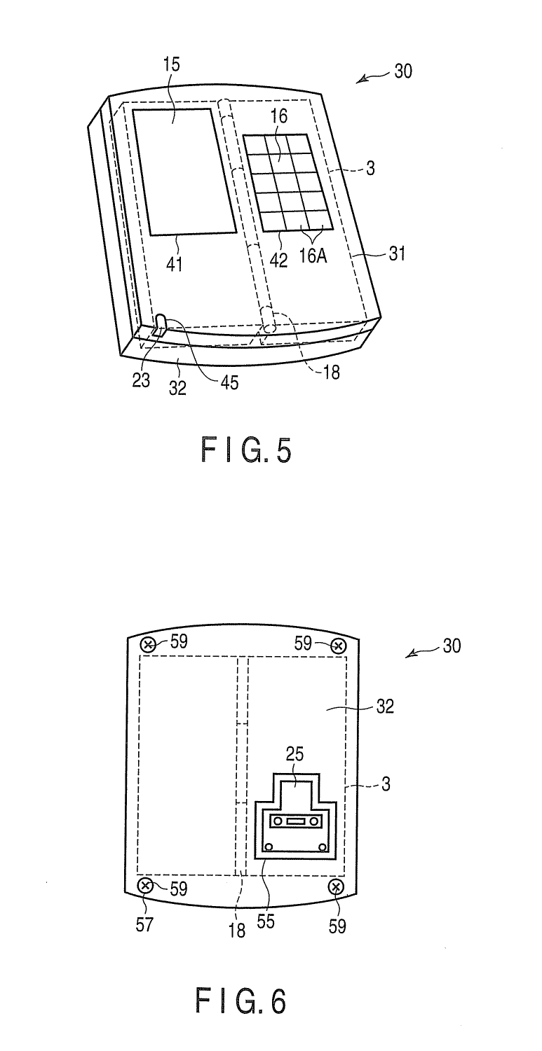

FIGS. 5 and 6 are diagrams of the communication device 30 incorporating the handy terminal 3 in the customer order mode. The communication device 30 includes the handy terminal 3 in the state in which the second component 12 is opened, a first cover (a front cover) 31 formed of a hard member such as metal, and a second cover (a rear cover) 32. The first cover 31 is attached to the handy terminal 3 from a front surface side of the handy terminal 3 exposed in the state in which the second component 12 is opened. The second cover 32 is attached to the handy terminal 3 from a rear surface side on the opposite side of the side exposed in the state in which the second component 12 is opened. The first cover 31 and the second cover 32 are attached to the handy terminal 3, whereby the front surface side of the handy terminal 3 is covered with the first cover 31 and the rear surface side of the handy terminal 3 is covered with the second cover 32. When the first cover 31 and the second cover 32 are covered, the opening and closing operation of the second component 12 of the handy terminal 3 is regulated by the first cover 31 and the second cover 32. The state in which the second component 12 is opened with respect to the first component 11 is maintained.

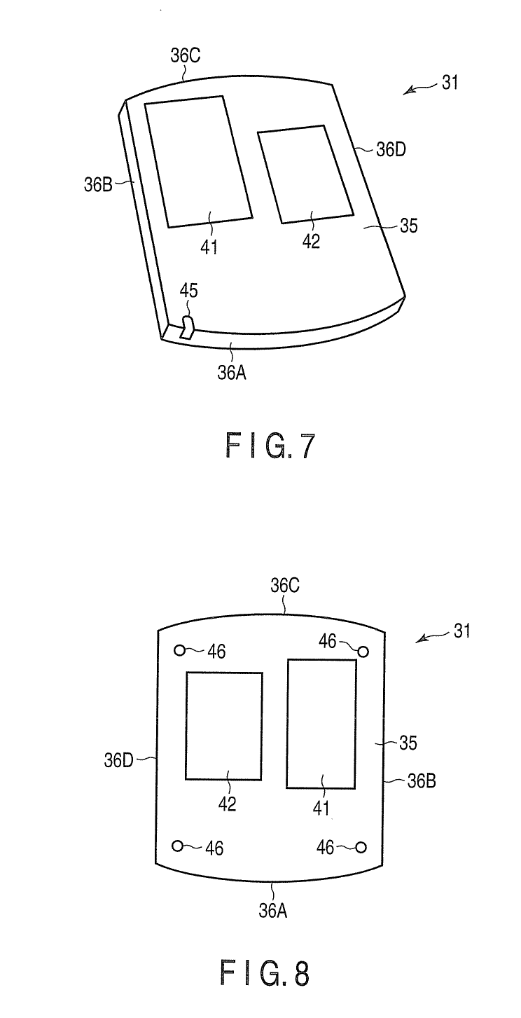

FIGS. 7 and 8 are diagrams of the configuration of the first cover 31. As shown in FIG. 7, the first cover 31 is formed in a shape for covering the entire front surface side of the handy terminal 3 in the state in which the second component 12 is opened. The first cover 31 includes a front panel 35 and four sidewalls 36A to 36D around the front panel 35. In the front panel 35 of the first cover 31, a display section window 41 and an operation button unit window 42 are provided to pierce through the front panel 35. As shown in FIG. 5, the display section window 41 is arranged in a position corresponding to the display section 15 when the first cover 31 and the second cover 32 are attached to the handy terminal 3. Similarly, the operation button unit window 42 is arranged in a position corresponding to the operation button unit 16 when the first cover 31 and the second cover 32 are attached to the handy terminal 3. The fastener 18 is arranged in a position corresponding to a partition wall between the display section window 41 and the operation button unit window 42.

A surface area of the display section window 41 is smaller than a surface area of the display section 15. When the first cover 31 and the second cover 32 are attached to the handy terminal 3, a portion of the display section 15 is exposed to the outside and the remaining portion is covered with the first cover 31. In other words, the display section 15 includes an exposed section exposed to the outside and an unexposed section covered with the first cover 31. A surface area of the operation button unit window 42 is smaller than a surface area of the operation button unit 16. When the first cover 31 and the second cover 32 are attached to the handy terminal 3, a portion of the operation button unit 16 is exposed to the outside and the remaining portion is covered with the first cover 31. In the portions of the display section 15 and the operation button unit 16 covered with the first cover 31, buttons unnecessary during the customer order mode such as the switching operation section, which is the button for switching an application, are arranged. Consequently, during the customer order mode, the customer can perform operation using only buttons necessary for an order. In this embodiment, portions of both the display section 15 and the operation button unit 16 are hidden by the cover 31. However, the present invention is not limited to this. For example, a portion of only the display section 15 may be hidden.

A cutout section for LED 45 is provided in a boundary portion between the front panel 35 and the sidewall 36A of the first cover 31. As shown in FIG. 5, the cutout section for LED 45 is arranged in a position corresponding to the LED 23 when the first cover 31 and the second cover 32 are attached to the handy terminal 3. Since the cutout section for LED 45 is provided, even when the first cover 31 and the second cover 32 are attached to the handy terminal 3, the lighting of the LED 23 can be checked from the cutout section for LED 45.

As shown in FIG. 8, four screw holes 46 are provided on a rear surface (a lower surface) of the front panel 35 of the first cover 31.

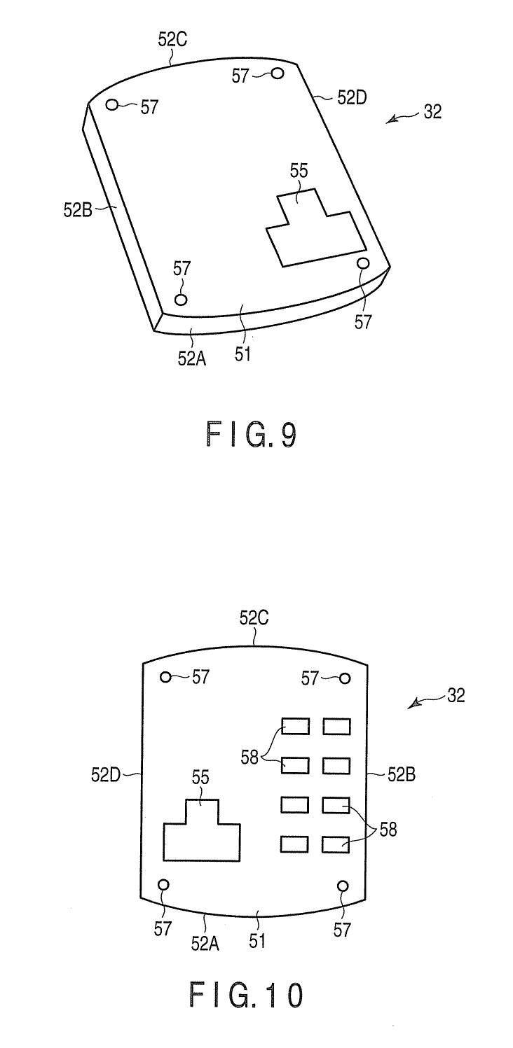

FIGS. 9 and 10 are diagrams of the configuration of the second cover 32. As shown in FIG. 9, the second cover 32 is formed in a shape for covering the entire rear surface side of the handy terminal 3 in the state in which the second component 12 is opened. The second cover 32 includes a bottom surface panel 51 and four sidewalls 52A to 52D around the bottom surface panel 51. A window for battery replacement 55 is provided in the bottom surface panel 51 of the second cover 32. As shown in FIG. 6, the window for battery replacement 55 is arranged in a position corresponding to a battery mounting section 25 of the handy terminal 3 when the first cover 31 and the second cover 32 are attached to the handy terminal 3.

As shown in FIG. 9, four through holes 57 are provided in the bottom surface panel 51 of the second cover 32. The respective through holes 57 are arranged in positions corresponding to the screw holes 46 of the first cover 31. When the first cover 31 and the second cover 32 are attached to the handy terminal 3, as shown in FIG. 6, four screws 59 are inserted into the screw holes 46 of the first cover 31 through the through holes 57 of the second cover 32 in a state in which the handy terminal 3 is arranged between the first cover 31 and the second cover 32. Male screw portions (not shown) of the screws 59 are screwed in the screw holes 46, whereby the first cover 31 and the second cover 32 are coupled.

As shown in FIG. 10, in the second cover 32, plural projections 58 projecting to the front surface side (the upper side) of the first component 11 and the second component 12 are provided in regions of the bottom surface panel 51 that are set in contact with the rear surface of the second component 12 when the first cover 31 and the second cover 32 are attached to the handy terminal 3. The thickness d1 of the first component 11 is large compared with the thickness d2 of the second component 12. Therefore, since the projections 58 are provided, when the first cover 31 and the second cover 32 are attached to the handy terminal 3, the front surface of the first component 11 and the front surface of the second component 12 are arranged on the same plane. Specifically, the projections 58 are position adjusting sections configured to arrange the front surface of the first component 11 and the front surface of the second component 12 on the same plane when the first cover 31 and the second cover 32 are attached to the handy terminal 3.

In this embodiment, the projections 58 are provided in the regions of the second cover 32 that are set in contact with the rear surface of the second component 12. However, in another embodiment, groove-like recesses may be provided in regions set in contact with the rear surface of the first component 11. In this case, the recesses function as the position adjusting sections configured to arrange the front surface of the first component 11 and the front surface of the second component 12 on the same plane when the first cover 31 and the second cover 32 are attached to the handy terminal 3. In this embodiment, the thickness d1 of the first component 11 is large compared with the thickness d2 of the second component 12. However, the thickness d1 of the first component 11 may be small compared with the thickness d2 of the second component 12. In this case, as in the case explained above, the position adjusting sections configured to arrange the front surface of the first component 11 and the front surface of the second component 12 on the same plane may be provided in the second cover.

Actions of the communication device 30 according to this embodiment are explained below.

The store clerk makes an order using the handy terminal 3. When the store clerk makes an order, in the handy terminal 3, the application in the store clerk order mode is started. First, the store clerk presses the power switch 21 to thereby turn on the power supply for the handy terminal 3. The store clerk inputs order data of the customer to the handy terminal 3 and transmits the order data to the radio communication unit 4. The order data transmitted to the radio communication unit 4 is transmitted to the kitchen printer 5 and the POS terminal 6 via the communication line 8.

On each of the tables in the store, the communication device 30 formed by attaching the first cover 31 and the second cover 32 to the handy terminal 3 in a state in which the second component 12 is opened with respect to the first component 11 is arranged. In the handy terminal 3, the application in the customer order mode is started. First, the customer touches the display section 15 of the handy terminal 3 of the communication device 30 to thereby turn on the power supply for the handy terminal 3. The customer inputs order data to the handy terminal 3 and transmits the order data to the radio communication unit 4. As in the case of the store clerk communication mode, the order data transmitted to the radio communication unit 4 is transmitted to the kitchen printer 5 and the POS terminal 6 via the communication line 8. When the customer is not using the handy terminal 3, the power supply for the handy terminal 3 is automatically turned off.

Switching of the application to be started between the store clerk order mode and the customer order mode is performed by performing operation for, for example, pressing the pre-set switching button of the operation button unit 16. An input in the operation button unit 16 is detected by the button-operation detecting section 71 and sent to the controller 70. The controller 70 sends the application switching command to the application switching section 78 on the basis of the input from the button-operation detecting section 71. The application switching section 78 switches, on the basis of the command from the controller 70, the application to be started. According to the switching of the application of the handy terminal 3, the display switching section 73 switches the display content of the display section 15 between the display content for the store clerk and the display content for the customer.

At least in the customer order mode, an error state of the handy terminal 3 such as a state in which the transmission button of the display section 15 for transmitting a data transmission command to the radio communication unit 4 is not pressed is detected by the input-operation detecting section 77 and sent to the controller 70. The controller 70 sends an LED lighting command to the LED control section 75 on the basis of an input from the input-operation detecting section 77. According to the LED lighting command, the LED control section 75 lights the LED 23. When the LED 23 is lit, the customer can check the lighting of the LED 23 from the cutout section for LED 45 provided in the first cover 31 of the communication device 30. Consequently, the customer checks the error state of the handy terminal 3.

When a battery of the battery mounting section 25 of the handy terminal 3 is replaced in a state in which the first cover 31 and the second cover 32 are attached to the handy terminal 3, the replacement of the battery is performed through the window for battery replacement 55 of the second cover 32 of the communication device 30.

When the first cover 31 and the second cover 32 are attached to the handy terminal 3, portions of the display section 15 and the operation button unit 16 are exposed to the outside and the remaining portions are covered with the first cover 31. In the portions of the display section 15 and the operation button unit 16 covered with the first cover 31, buttons unnecessary during the customer order mode such as the button for switching an application (the switching operation section) are arranged. Consequently, during the customer order mode, the customer can perform operation using only buttons necessary for an order. In other words, the customer is prevented from pressing the buttons unnecessary during the customer order mode by mistake. For example, start of the application in the store clerk order mode because of operation of the button for switching an application by the customer by mistake is prevented.

### Modification of the First Embodiment

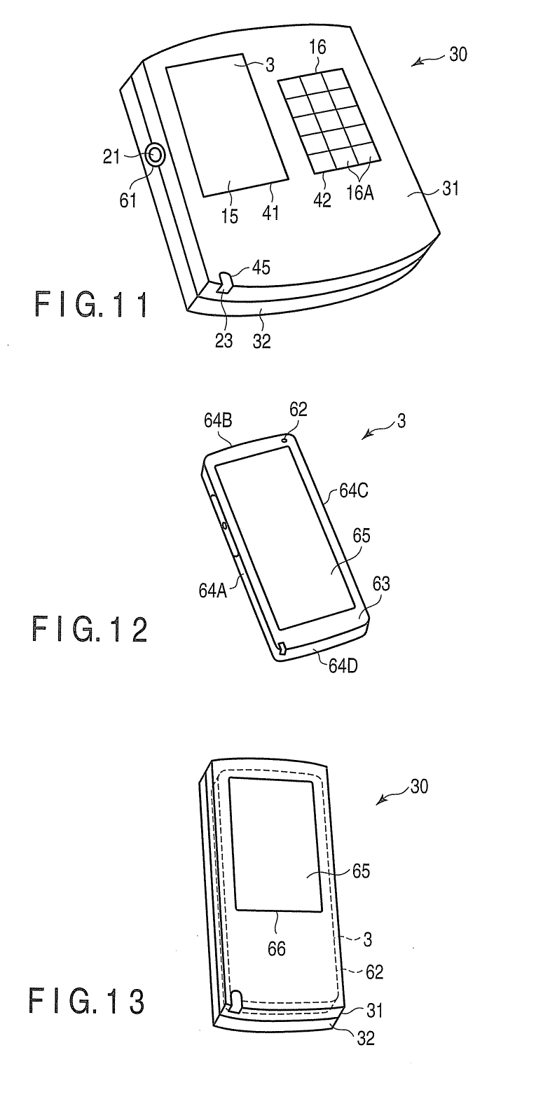

In the handy terminal 3 of the embodiment explained above, in the customer order mode, the power supply is turned on when the customer touches the display section 15. However, as a modification, in the customer order mode, as in the store clerk order mode, the power supply may be turned on when the customer presses the power switch 21. In this case, as shown in FIG. 11, a power switch hole 61 is provided in a boundary portion between the first cover 31 and the second cover 32. The power switch hole 61 is arranged in a position corresponding to the power switch 21 when the first cover 31 and the second cover 32 are attached to the handy terminal 3.

The handy terminal 3 of the embodiment explained above includes the first component 11 and the second component 12 pivotable with respect to the first component 11. However, in another embodiment, the handy terminal 3 is not limited to this. For example, as a modification, as shown in FIG. 12, the handy terminal 3 may include a single component 62 having a substantially rectangular parallelepiped shape. The component 62 includes a front surface 63, a rear surface (not shown) opposed to the front surface 63, and four sides 64A to 64D. A display section of a touch panel type and an operation section 65 such as an operation button unit are provided on the front surface 63 of the component 62. According to operation in the operation section 65, input of order data, transmission of the data, and the like are possible.

As shown in FIG. 13, in the communication device 30 of this modification, the first cover 31 is attached from the front surface 63 (a surface on which the operation section 65 is provided) side of the handy terminal 3. The second cover 32 is attached from the rear surface (a surface opposed to the surface on which the operation section 65 is provided) side. The first cover 31 includes an operation section window 66 arranged in a position corresponding to the operation section 65 when the first cover 31 and the second cover 32 are attached to the handy terminal 3. Therefore, the customer can easily perform input of order data, transmission of the data, and the like by operating the operation section 65 of the handy terminal 3 of the communication device 30. In this modification, when the first cover 31 and the second cover 32 are attached to the handy terminal 3, a portion of the operation section 65 is exposed to the outside and the remaining portion is covered with the first cover 31. In other words, the operation section 65 includes an exposed section exposed to the outside and an unexposed section covered with the first cover 31. In the portions of the operation section 65 covered with the first cover 31, buttons unnecessary during the customer order mode such as the button for switching an application are arranged. Consequently, during the customer order mode, the customer can perform operation using only buttons necessary for an order.

In the modification of the embodiment, the display section 15 may be covered with a thin transparent film or the like. Consequently, since the user can perform input of order data, transmission of the data, and the like without directly touching the display section 15, it is possible to prevent stains of the display section 15.

In this embodiment, the LED 23 is provided in the boundary portion of the front surface 11A of the first component 11 and the side 11C on the lower side in FIG. 2. However, as a modification, the LED 23 may be provided in, for example, a boundary portion between the rear surface 11D on the opposite side of the front surface 11A and the side 11C. In this case, the cutout section for LED 45 is provided in the second cover 32 in order to arrange the cutout section for LED 45 in a position corresponding to the LED 23 when the first cover 31 and the second cover 32 are attached to the handy terminal 3. In other words, in some case, the cutout section for LED 45 is provided in the second cover 32 or the boundary portion between the first cover 31 and the second cover 32 rather than in the first cover 31 to correspond to the position of the LED 23. The window for battery replacement 55 and the power switch hole 61 are provided in the same manner as the cutout section for LED 45. Specifically, in a certain modification, in some case, the window for battery replacement 55 is provided in the first cover 31 or the boundary portion between the first cover 31 and the second cover 32 rather than in the second cover 32 to correspond to the position of the battery mounting section 25. Similarly, in another certain modification, in some case, the power switch hole 61 is provided in the first cover 31 or the second cover 32 rather than in the boundary portion between the first cover 31 and the second cover 32 to correspond to the position of the power switch 21.

In the embodiment, the LED is used as the warning section for checking the error state of the handy terminal 3. However, as a modification, the error state may be checked by using other components such as a buzzer.

In the embodiment, the application to be started is switched by performing the operation of the operation button unit 16. However, in a certain modification, the application to be started may be switched by performing the operation of the display section 15. In this case, the controller 70 sends the application switching command to the application switching section 78 on the basis of an input from the input-operation detecting section 77. In other words, the handy terminal 3 only has to include a switching operation section configured to switch display content of the display section 15. Similarly, the transmission button for transmitting the data transmission command to the radio communication unit 4 may be provided in the operation button unit 16 rather than in the display section 15.

In the embodiment, the male screw portions (not shown) of the screws 59 are screwed in the screw holes 46, whereby the first cover 31 and the second cover 32 are coupled. However, the present invention is not limited to this. For example, in a certain modification, the first cover 31 and the second cover 32 may be coupled by, for example, providing a fitting portion of the first cover 31 and the second cover 32.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a communication terminal including a first component having a display section provided on a front surface, a second component having an operation button unit provided on a front surface, and a coupling section configured to openably and closably couple the first and second components; and
a first cover configured to cover a front surface of the communication device in a state in which the first and second components are open and including at least two windows arranged in positions corresponding to the display section and the operation button unit.

2. The device according to claim 1, wherein the communication terminal includes:
a switching operation section provided in one of the operation button unit and the display section and configured to perform operation for switching display content of the display section between a store clerk order mode in which a store clerk individually carries the communication terminal and makes an order and a customer order mode in which a customer makes an order on a table; and
a display switching section configured to switch, according to the operation in the switching operation section, the display content of the display section between the store clerk order mode and the customer order mode.

3. The device according to claim 1, wherein the communication terminal includes a warning section configured to warn, at least in the customer order mode, an error state of the communication terminal.

4. The device according to claim 3, further comprising a second cover configured to cover a rear surface of the communication terminal, wherein
the warning section includes an LED that is lit when the error state of the communication terminal is warned, and
the device has a cutout section for LED provided in any one of the first cover, the second cover, and a boundary portion between the first cover and the second cover and arranged in a position corresponding to the LED.

5. The device according to claim 2, wherein the communication terminal includes a terminal control section configured to control the communication terminal such that, in the customer order mode, a power supply is turned on when the customer touches the display section and the power supply is automatically turned off when the customer does not use the communication terminal.

6. The device according to claim 1, further comprising a second cover configured to cover a rear surface of the communication terminal, wherein the device has a window for battery replacement provided in any one of the first cover, the second cover, and a boundary portion between the first cover and the second cover and arranged in a position corresponding to a battery mounting section provided in the communication terminal.

7. The device according to claim 1, wherein one window of the at least two windows hides a portion of the operation button unit or the display section from an outside.

8. The device according to claim 7, wherein one of the operation button unit and the display section includes, in a position hidden from the outside by the first cover, a switching operation section configured to perform operation for switching display content of the display section between a store clerk order mode in which a store clerk individually carries the communication terminal and makes an order and a customer order mode in which a customer makes an order on a table.

9. The device according to claim 1, further comprising a second cover configured to cover a rear surface of the communication terminal, wherein
the second cover includes a position adjusting section configured to arrange the front surface of the first component and the front surface of the second component on a same plane.

10. A communication device comprising:
a communication terminal including an operation section on a front surface; and
a cover configured to cover a side of the communication terminal on which the operation section is provided and including a window for exposing a portion of the operation section to the outside, wherein
the operation section includes, in a position covered with the cover, a mode switching section configured to switch a mode.

11. The device according to claim 10, wherein the operation section includes a switching operation section provided in the mode switching section and configured to perform operation for switching display content of the display section between a store clerk order mode in which a store clerk individually carries the communication terminal and makes an order and a customer order mode in which a customer makes an order on a table.

12. A cover unit configured to cover a communication terminal including a first component and a second component that is opened and closed between a state in which the second component is opened with respect to the first component and a state in which the second component is closed with respect to the first component, the cover unit comprising:
a first cover attached to a front surface side of the first component and the second component exposed to an outer side in the state in which the second component is opened; and
a second cover attached to a rear surface side of the first component and the second component on an opposite side of the front surface side in a state in which the second component is opened, wherein
the first cover includes:
a display section window arranged in a position corresponding to a display section provided on the front surface of the first component when the cover unit is attached to the communication terminal; and
an operation button unit window arranged in a position corresponding to an operation button unit provided on the front surface of the second component when the cover unit is attached to the communication terminal.
